(19) United States
(12) Patent Application Publication
(10) Pub. No.: US 2009/0327175 A1
(43) Pub. Date: Dec. 31, 2009

(54) PHARMACOKINETIC MODELING OF MYCOPHENOLIC ACID

(76) Inventors: Xiang He, London (GB); David W. Holt, Surrey (GB); Atholl Johnston, London (GB)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 12/374,424

(22) PCT Filed: Jul. 19, 2007
(86) PCT No.: PCT/EP07/06453

§ 371 Date: Jan. 20, 2009

(30) Foreign Application Priority Data
Jul. 21, 2006 (EP) 06117670.7
Jan. 31, 2007 (EP) 07101456.7

(51) Int. Cl. G06N 5/02; G06F 15/18; G06F 17/10; G06G 7/60

(52) U.S. Cl. 706/12; 706/52; 703/2; 703/11

(57) ABSTRACT

A method of providing a pharmacokinetic model to provide optimize pharmacokinetic data associated with administering a drug to a patient and a method of optimising pharmacokinetic data associated with administering a drug to a patient, data processing apparatus, recording medium and a pharmacokinetic model are disclosed.

The present invention relates to pharmacokinetic modelling, e.g. a Baysian approach, to estimate exposure based on demographic data, i.e. without using biological samples. Embodiments of the present invention relate to a method of predicting an effective dosage of mycophenolic acid (MPA), a pharmaceutically acceptable salt thereof or a prodrug thereof for treating or preventing transplantation rejection. Embodiments also relate to a pharmakocinetic model to determine, e.g. predict, an effective dosage of MPA, a pharmaceutically acceptable salt thereof or a prodrug thereof for treating or preventing transplantation rejection, and a method for generating such a pharmakocinetic model.

Embodiments further relate to a data processing apparatus, recording medium and programming code, e.g. algorithm.

### BACKGROUND OF THE INVENTION

Mycophenolic acid, also referred to herein as MPA, was first isolated in 1896. It is a potent, selective, non-competitive and reversible inhibitor of inosine-5′-monophosphate dehydrogenase (IMPDH). Mycophenolic acid therapy significantly reduces the risk of biopsy-proven acute rejection and improves graft survival following transplantation. Mycophenolate mofetil (MMF, Cellcept® from Roche) and enteric coated Mycophenolate sodium (Myfortic® from Novartis) are now used widely in combination with cyclosporine (CsA) and corticosteroids for treating or preventing renal graft rejection.

When administering a drug to a subject patient, it is important to ensure that the correct dosing for that patient is achieved. Whilst much empirical information is often available to enable a clinician to make a determination of the likely correct dosing rate for a patient, there typically remains a fair degree of uncertainty as to the optimal dose to be provided in any particular circumstance. However, clinical experience can often be relied upon to help the clinician to determine the correct dose to be administered. When making this judgement, the clinician will need to balance competing factors, if less than an effective dose is administered then the drug may be ineffective, whereas if greater than the effective dose is administered then undesirable side effects may be experienced.

In order to improve patient care and outcomes, it becomes more and more important to individualise dose even for drug with large therapeutic index in order to maximize the benefit-risk ratio for the patient, herein maximizing the efficacy while minimising the occurrence of side effects.

In particular, there is a need to improve MPA therapy, in particular to better individualise MPA therapy, in order to reach optimal exposure to the drug and to enhance the benefit-risk ratio of the treatment for the transplant patient, in order to improve long term graft survival, decrease short term and long term side effects, as well as improve patient well being.

In addition there may be desirable to reduce the economic costs to the health provider.

One way to tailor a given therapy to an individual is to look at the exposure over time in the blood collecting blood samples. However this approach has limitation due to the high intra patient variability for certain type of drugs such as mycophenolic acid salt or prodrug thereof, particularly in case of enteric coated formulation, potentially resulting in erroneous therapeutic changes leading to loss of efficacy or increase in occurrence of side effects.

More particularly there is a need to provide such an improved technique, e.g. to develop a pharmacokinetic model, e.g. a Baysian approach, to estimate exposure based on demographic data, which does not use blood samples while permitting similar accuracy than using blood samples.

In addition, the improved technique saves staff, patient and laboratory time and is more cost effective. Added to that the measurement of MPA plasma concentrations is expensive and the ability to do this is not widely available.

### SUMMARY OF THE INVENTION

The present invention provides a method and pharmacokinetic model to estimate exposure of mycophenolic acid (MPA), pharmaceutically acceptable salt thereof or prodrug thereof, and thus to optimise MPA therapy for de novo and stable transplant patients, in particular renal transplant patients. The method according to the present invention permits to individualize MPA therapy for transplant patients, de novo or stable transplant patients.

The pharmacokinetic model and method according to the invention can be used for de novo and stable transplant patients, e.g. renal transplant patients, receiving MPA, e.g. enteric coated mycophenolate salt, as part of their immunosuppressive drug regime.

The present invention further provides a method and pharmacokinetic model to determine, e.g. predict, the effective amount of MPA, pharmaceutically acceptable salt thereof or prodrug thereof, for treating or preventing transplant rejection in transplant patients, e.g. renal transplant patients, receiving MPA, for example as enteric coated mycophenolate salt, as part of their immunosuppressive drug regime.

The present invention is based on patient's demographic information only, such as gender, height, weight, age, i.e. avoids using and collecting biological samples, such as blood samples.

According to a first aspect of the present invention there is provided a method of determining, e.g. predicting, the effective amount of a drug for treating or preventing transplantation rejection, in a subject in need of such treatment, said method comprising the steps of

i) obtaining parameters of the subject comprising the gender, age, body mass index, and

ii) determining, e.g. predicting, the effective amount of the drug based on the parameters obtained under step i),

wherein said method does not require the use of biological samples, e.g. blood samples, from the subject.

As hereinabove defined, the “effective amount of the drug” refers to the amount of the drug to be administered to the subject in order to reach the optimal amount of the active substance in the blood, also called the optimal drug exposure or drug AUC, which permits to obtain the maximal drug efficacy.

In case of the present invention, the maximal efficacy of the drug of the invention refers to prevention of transplantation rejection.

The active substance of the drug is the drug or part of thereof which provides the desired therapeutic effect when has reached the blood of the patient. According to the present invention, the active substance is MPA.

AUC refers to Area under the Curve; it corresponds to the exposure of the drug, i.e. the amount of the active substance of the drug which reaches the blood after or during a specific period of time. In case of the drug of the invention, the specific period of time is preferably 12 hours (AUC is then referred as AUC₀₋₁₂)

According to the present invention, the drug is selected from mycophenolic acid (MPA), salt and prodrug thereof, e.g. mycophenolate mofetil, mycophenolate salt, e.g. mycophenolate sodium (hereindefined as the drug of the invention). Preferably the drug of the invention is selected from MPA and mycophenolate salt. A preferred mycophenolate salt is mycophenolate sodium, e.g. monosodium.

In one preferred embodiment of the invention, the drug of the invention is administered as a delayed release MPA formulation, e.g. an enteric coated composition comprising mycophenolate salt, e.g. enteric coated composition comprising mycophenolate sodium.

In case of the drug of the invention, the effective amount is obtained for a MPA exposure (i.e. MPA AUC, preferably MPA AUC₀₋₁₂) of at least 30 mg·h/ml.

According to the invention, the effective amount of the drug of the invention is determined, e.g. predicted, based on the gender, age and body mass index, of the subject.

According to the invention, the effective amount of the drug of the invention is further determined, e.g. predicted, based on additional parameters selected from MPA absorption rate, volume of distribution, MPA elimination rate, renal clearance, target MPA exposure (i.e. target MPA AUC), MPA lag time and time between doses.

The term “MPA absorption rate” as used herein (also referred as “ka”) refers to the rate of the movement of MPA into blood stream.

The term “volume of distribution” as used herein (also referred as “v”) refers to the volume in which the amount of MPA would need to be uniformly distributed in to produce the observed blood concentration

The term “MPA elimination rate” as used herein (also referred as “kel”) refers to the rate of MPA elimination from the body.

The term “renal clearance” as used herein refers to the measure of the speed at which a constituent of urine passes through the kidney.

The term “MPA AUC” as used herein refers to the MPA exposure, i.e. the area under the curve of concentration of MPA present in the blood of the patient.

The term “target MPA AUC” as used herein (also referred as “AUC_{target}”) refers to the MPA AUC that is required to achieve the maximal efficacy of the drug of the invention after the drug of the invention is administered to the patient, i.e. to prevent transplantation rejection. In case of the drug of the invention, the drug is administered preferably twice a day, and the target MPA AUC corresponds preferably to the target MPA AUC₁₋₁₂.

According to the invention, the “target MPA AUC” is between 30 mg·h/ml and 60 mg·h/ml, preferably is at least 30 mg·h/ml, preferably is about 45 mg·h/ml.

The term “MPA lag time” as used herein (also referred as “lag”) refers to the period of time elapsed between taking the drug of the invention and the appearance of MPA in the blood stream.

The term “time between doses” as used herein (also referred as “tlast”) refers to the period of time between two subsequent administrations of the drug of the invention to the patients to be treated. Preferably the time between doses is about 12 hours.

The above-mentioned terms are well known by the one skilled in the art, e.g. the clinician or medical doctor who administer MPA to the transplant patients.

In a preferred embodiment of the invention, the effective amount of the drug of the invention is further determined, e.g. predicted, based on MPA absorption rate, volume of distribution, MPA elimination rate and renal clearance, e.g. body system rates of flow.

According to another aspect of the invention, the effective amount of the drug of the invention is further determined, e.g. predicted, based on target MPA AUC, MPA lag time and time between doses.

In another embodiment of the invention, there is provided a pharmacokinetic model to determine, e.g. predict, the effective amount of a drug selected from MPA, a pharmaceutically acceptable salt thereof and a prodrug thereof, for treating or preventing transplantation rejection, in a subject in need of such treatment, wherein said model determines, e.g. predicts, the effective amount of the drug based on the gender, age, body mass index of the subject. The model of the invention may be also based on MPA absorption rate, volume of distribution, MPA elimination rate and renal clearance, e.g. body system rates of flow. The model of the invention may be further based on target dose, MPA lag time and time between doses.

In another embodiment of the invention, there is provided a method of determining, e.g. predicting, the MPA exposure, as herein defined as “predicted MPA exposure”, reached after a single administration of the drug of the invention by an individual subject.

According to the invention, the predicted MPA exposure is based on the drug dose, as well as parameters selected from gender, age and body mass index of the subject.

The term “drug dose” as used herein refers to the dose of the drug of the invention taken by the patient. Preferably the drug dose is 720 mg of the drug of the invention, preferably of mycophenolate salt, preferably of enteric coated mycophenolate salt. Preferably the dose is taken twice a day, i.e. is 720 mg bid.

According to the invention, the predicted MPA exposure is further based on MPA absorption rate, MPA lag time, volume of distribution, MPA elimination rate, and time between doses.

In another embodiment of the invention, there is provided a pharmacokinetic model to determine the predicted MPA exposure as hereinabove defined based on the drug dose, as well as parameters selected from the gender, age, body mass index of the subject. The model to determine the predicted MPA exposure may be also based on MPA absorption rate, volume of distribution, MPA elimination rate and renal clearance, e.g. body system rates of flow. The model of the invention may be further based on target dose, MPA lag time and time between doses.

According to the invention, MPA absorption rate comprises a term based on the gender and body mass index of the subject.

In one embodiment, MPA absorption rate comprises a term based a first predetermined constant summed with a function based on the gender factored by a second predetermined constant summed with the body mass index factored by a third predetermined constant.

In one embodiment, MPA lag time comprises a fourth predetermined constant.

In one embodiment, the volume of distribution comprises a term based on the age of the subject.

In one embodiment, the volume of distribution comprises a term based on a fifth predetermined constant summed with the age factored by a sixth predetermined constant.

In one embodiment, MPA elimination rate comprises a term based on a function based on the gender and the body mass index of the subject.

In one embodiment, MPA elimination rate comprises a term based a seventh predetermined constant summed with a function based on the gender factored by an eighth predetermined constant summed with the body mass index factored by a ninth predetermined constant.

In one embodiment, the renal clearance, e.g. body system rates of flow, comprise a first body system rate of flow representative of a flow rate from a first component of the subject to a second component of the subject and a second body system rate of flow representative of a flow rate from the second component of the subject to the first component of the subject.

After administration, a drug may be distributed into all of the accessible regions of the body instantly. In such a case the body can be considered as a homogenous container for the drug, e.g. like a beaker containing a single solvent where the drug is homogenously distributed, and the disposition kinetics of the drug can be described as a “one compartment open model”. The wording ‘open’ refers to the fact that, unlike a beaker model, the drug is eliminated from the container. But most of the drugs distribute into the vascular space and some readily accessible peripheral spaces in a much faster rate than into deeper tissues. Furthermore most drugs are eliminated from the vascular system not only via simple elimination but also through distribution to other tissues. In such cases the one compartment open model is not adequate. The disposition kinetics of the drug can then be described according to a “two compartment open model”, comprising a first compartment, e.g. central compartment, and a second compartment, e.g. tissue compartments.

In one embodiment, the first body system rate of flow comprises a tenth predetermined constant.

In one embodiment, the second body system rate of flow comprises a term based on the body mass index of the subject.

In one embodiment, the second body system rate of flow comprises a term based an eleventh predetermined constant summed with the body mass index factored by a twelfth predetermined constant.

In one embodiment, the terms further comprise one or more derived terms derived from one or more of MPA absorption rate, MPA lag time, volume of distribution, MPA elimination rate and renal clearance.

In one embodiment, the derived terms include a first derived term based on the body system rates of flow and the elimination rate.

In one embodiment, the first derived term comprises the first body system rate of flow summed with the second body system rate of flow summed with the elimination rate.

In one embodiment, the derived terms include a second derived term based on the first derived term and renal clearance, e.g. body system rate of flow.

In one embodiment, the second derived term comprises the square root of the first derived term squared summed with the product of the first body system rate of flow and the second body system rate of flow factored by a thirteenth predetermined constant.

In one embodiment, the derived terms include a third derived term based on the first derived term and the second derived term.

In one embodiment, the third derived term comprises the sum of the first derived term and the second derived term factored by a fourteenth predetermined constant.

In one embodiment, the derived terms include a fourth derived term based on the first derived term and the third derived term.

In one embodiment, the fourth derived term comprises the first derived term summed with the third derived term.

In one embodiment, the derived terms include a fifth derived term based on the volume of distribution, the body rate system of flow, the third derived term and the fourth derived term.

In one embodiment, the fifth derived term comprises the reciprocal of the second body system rate of flow summed with the third derived term divided by the fourth derived term summed with the third derived term factored by the volume of distribution.

In one embodiment, the derived terms include a sixth derived term based on the volume of distribution and the fifth derived term.

In one embodiment, the sixth derived term comprises the reciprocal of the fifth derived term summed with the volume of distribution.

In one embodiment, the derived terms include a seventh derived term based on the fifth derived term, the absorption rate and the third derived term.

In one embodiment, the seventh derived term comprises the fifth derived term factored by the absorption rate divided by the absorption rate factored by the third derived term.

In one embodiment, the derived terms include an eighth derived term based on the sixth derived term, the absorption rate and the fourth derived term.

In one embodiment, the eighth derived term comprises the sixth derived term factored by the absorption rate divided by the absorption rate factored by the fourth derived term.

According to the present invention there are provided a method to determine, e.g. predict, MPA AUC value obtained e.g. 12 hours after MPA administration (AUC₀₋₁₂).

In one embodiment, there is predicted an effective amount of MPA, e.g. predicted dose, based one the following equations:

Effective amount of MPA, e.g. predicted dose=AUC_{target}/((u*exp(e*lag)*(exp(−e*tlast)−exp(−e*lag))/(−e)+w*exp(f*lag)*(exp(−f*tlast)−exp(−f*lag))/(−f−(u+w)*exp(ka*lag)*(exp(−ka*tlast)−exp(−ka*lag))/(−ka))), (i)

wherein

AUC_{target}=target MPA AUC

tlast=12;

ka=0.40−0.15*sexi+0.12*bmii;

lag=0.2;

v=9.5+0.24*age;

kel=0.54+0.15*sexi−0.12*bmii;

k12=0.54;

k21=44.1+1.4*bmi;

K=k21+k12+kel;

D=SQRT(K*K−4*k21*k12);

e=(K+D)/2;

f=K−e;

A_dose=1/V*(k21−e)/(f−e);

B_dose=1/V−A;

u=A_dose*Ka/(Ka−e);

w=B_dose*Ka/(Ka−f);

age, sexi, bmi, bmii and bmib are as hereinbelow described, tlast refers to time between dose, ka refers to MPA absorption rate, lag refers to MPA lag time, v refers to volume of distribution, kel refers to MPA elimination rate; K refers to first derived value; D refers to second derived value, e refers to third derived value, f refers to fourth derived value, A_dose refers to fifth derived value, B_dose refers to sixth derived value, u refers to seventh derived value, and w refers to eight derived value, (Equation P1).

Effective amount of MPA, e.g. predicted dose=AUC_{target}/(b₁*c₁*exp(d₁)−b₁*c₁*exp(e₁)), (ii)

wherein

AUC_{target}=target MPA AUC;

ka₁=0.75−0.05*sex+0.02*bmii;

lag₁=0.0002;

v₁=60.82+0.04*age;

kel₁=0.1108+0.0039*bmi;

b₁=(−kel₁)/(v₁*(Ka₁−kel₁));

c₁=tlast₁−lag₁;

d₁=(−ka₁*(tlast₁−lag₁));

e₁=ka₁*lag₁;

and age, sexi, bmi, bmii and bmib are as hereinbelow described,
ka₁ refers to MPA absorption rate,
lag₁ refers to MPA lag time,
v₁ refers to volume of distribution, and
kel₁ refers to MPA elimination rate (Equation P2).

Effective amount of MPA, e.g. predicted dose=AUC_{target}/(b₂*c₂*exp(d₂)−b₂*c₂*exp(e₂)), (iii)

wherein

AUC_{target}=target MPA AUC;

ka₂=0.98−0.05*sex-0.014*bmi+0.006*sqrt(age);

lag₂=0.01−0.0003*sqrt(age)−0.0001*sex−0.0001*bmib;

v₂=60.82+0.08*sqrt(age)+25*bmii;

kel₂=0.11+0.003*bmi-0.0085*sqrt(age)−0.01*sex;

b₂=(−kel₂)/(v*(Ka₂−kel₂));

c₂=tlast₂−lag₂;

d₂=(−ka₂*(tlast₂−lag₂));

e₂=ka₂*lag₂;

and age, sexi, bmi, bmii and bmib are as hereinbelow described, ka₂ refers to MPA absorption rate, lag₂ refers to MPA lag time, v₂ refers to volume of distribution, and kel₂ refers to MPA elimination rate (Equation P3).

In another embodiment of the invention, there is provided a predicted MPA exposure”, e.g. predicted area under the curve of MPA in accordance with one of the following the equations:

(Equation A1)

Predicted MPA exposure, e.g. predicted area under the curve, =dose*((u*exp(e*lag)*(exp(−e*tlast)−exp(−e*lag))/(−e)+w*exp(f*lag)*(exp(−f*tlast)−exp(−f*lag))/(−f)−(u+w)*exp(ka*lag)*(exp(−ka*tlast)−exp(−ka*lag))/(−ka))), (iv)

wherein

tlast=12;

ka=0.40−0.15*sexi+0.12*bmii;

lag=0.2;

v=9.5−0.24*age;

kel=0.54+0.15*sexi-0.12*bmii;

k12=0.54;

k21=44.1+1.4*bmi;

K=k21+k12+kel;

D=SQRT(K*K−4*k21*k12);

e=(K+D)/2;

f=K−e;

A_dose=1/V*(k21−e)/(f−e);

B_dose=1/V−A_dose; u=A_dose*Ka/(Ka−e); and

w=B_dose*Ka/(Ka−f);

age, sexi, bmi, and bmii are as hereinbelow described,
dose refers to drug dose as hereinabove defined;
tlast refers to time between dose,
ka refers to MPA absorption rate,
lag refers to MPA lag time,
v refers to volume of distribution,
kel refers to MPA elimination rate
k12 refers to rate constant between the first, e.g. central, compartment and second, e.g. tissues, compartment;
k21 refers to rate constant between the second, e.g. tissues, compartment and first, e.g. central, compartment;
K refers to first derived value;
D refers to second derived value;
e refers to third derived value;
f refers to fourth derived value;
A_dose refers to fifth derived value;
B_dose refers to sixth derived value;
u refers to seventh derived value; and
w refers to eight derived value

Predicted MPA exposure, e.g. predicted area under the curve, =dose*b₁*c₁*exp(d₁)−dose*b₁*c₁*exp(e₁); (v)

wherein

ka₁=0.75−0.05*sex+0.02*bmii;

lag₁=0.0002;

v₁=60.82+0.04*age;

kel₁=0.1108+0.0039*bmi;

b₁=(−kel₁)/(v₁*(Ka₁−kel₁));

c₁=tlast₁−lag₁;

d₁=(−ka₁*(tlast₁−lag₁));

e₁=ka₁*lag₁;

age, sexi, bmi, and bmii are as hereinbelow described,
dose refers to drug dose as hereinabove defined,
ka₁ refers to MPA absorption rate, lag₁ refers to MPA lag time, v₁ refers to volume of
distribution, and kel₁ refers to MPA elimination rate (Equation A2)

Predicted MPA exposure, e.g. predicted area under the curve, =dose*b₂*c₂*exp(d₂)−dose*b₂*c₂*exp(e₂)),

wherein

ka₂=0.98−0.05*sex−0.014*bmi+0.006*sqrt(age);

lag₂=0.01−0.0003*sqrt(age)−0.0001*sex−0.0001*bmib;

v₂=60.82+0.08*sqrt(age)+25*bmii;

kel₂=0.11+0.003*bmi−0.0085*sqrt(age)−0.01*sex;

b₂=(−kel₂)/(v₂*(Ka₂−kel₂));

c₂=tlast₂−lag₂;

d₂=(−ka₂*(tlast−lag₂));

e₂=ka₂*lag₂;

age, sexi, bmi, bmii and bmib are as hereinbelow described,
dose refers to drug dose as hereinabove defined,
ka₂ refers to MPA absorption rate, lag₂ refers to MPA lag time, v₂ refers to volume of distribution, and kel₂ refers to MPA elimination rate (Equation A3).

For the purpose of the present invention, the terms age, dose, sexi, bmii, bmi, and bmiib are as hereinbelow defined:

age is the age of the subject;

dose refers to drug dose as hereinabove defined; is preferably about 720 mg MPA, e.g. administered as enteric coated composition containing mycophenolate salt;

sexi is ‘0’ when the gender of the subject is male and ‘1’ when the gender of the subject is female;

bmii is ‘0’ when the gender of the subject is male and ‘1’ when the gender of the subject is female;

bmi is the body mass index of the subject;

bmii is ‘0’ when the bmi of the subject is out side normal range [18, 25] and ‘1’ when the bmi of the subject is within [18, 25];

bmib is ‘0’ when the bmi of the subject is equal or less than 30 and ‘1’ when the bmi of the subject is greater than 30.

Equations P1, A1, P3 and A3 are preferred.

Preferably Equations P1 and A1 are to be used in case of stable patients, and Equations P3 and A3 in case of de novo patients.

As used herein, “stable patients” refers to patients transplanted for at least 6 months under immunosuppressive drug regimen and for which there is no transplantation rejection, or transplantation rejection event for at least 6 months.

In another embodiment of the invention there is provided, e.g. predicted, an effective amount of MPA, e.g. predicted dose, in accordance with the following equations:

(Equation P4)

Predicted dose=dummy*f(dose,s)+(1−dummy)*f(dose,d); (vii)

wherein dummy, f(dose,s), and f(dose,d) are as hereinbelow described.

In another embodiment of the invention there is provided a predicted MPA exposure, e.g. predicted area under the curve of MPA, in accordance with the following the equation

(Equation A3)

Predicted MPA exposure, e.g. predicted area under the curve, =dummy*f(AUC₀₋₁₂,s)+(1−dummy)*f(AUC₀₋₁₂,d); (viii)

wherein

dummy=1 when patients are stable, and dummy=0 when patients are de novo patients;

f(AUC₀₋₁₂,s) is equation for predicted area under the curve in case of stable patient, e.g. Equation A1;

f(dose,s) is equation for predicted dose in case of stable patient; e.g. Equation P1;

f(AUC₀₋₁₂,d) is equation for predicted area under the curve in case of de novo patient, e.g. Equation A2 or A3, preferably A3; and

f(dose,d) is equation for predicted dose in case of de novo patient, e.g. Equation P2 or P3, preferably P3;

According to the present invention there is further provided
1. A method for treating or preventing transplantation rejection, in a subject in need of such treatment, which method comprises administering to said subject an effective amount of a MPA, a pharmaceutically acceptable salt thereof and a prodrug thereof, wherein the effective amount is determined, e.g. predicted, by a predicting method or a pharmacokinetic model as hereinabove defined.
2. Use of a drug selected from MPA, a pharmaceutically acceptable salt thereof and a prodrug thereof in the manufacture of a medication, whereby the effective dosage of the drug is predicted by a method or a pharmacokinetic model as hereinabove defined.
3. A method of determining, e.g. predicting, an effective amount of a drug for treating or preventing transplantation rejection in a subject in need thereof comprising the steps of a) inputting a plurality of parameters into a computer, wherein said parameters comprise gender, age, and body mass index of said subject; b) storing a computer program, e.g. a programming code, e.g. prediction algorithm, in said computer; c) calculating said effective amount from said computer program, e.g. a programming code, e.g. prediction algorithm, with said parameters; wherein said drug is selected from a group consisting of MPA, a pharmaceutically acceptable salt thereof and a prodrug thereof.
4.1 A computer program, e.g. programming code, e.g. prediction algorithm, which, when executed on a data processing apparatus, e.g. a computer, performs the method steps of the predicting method as hereinabove defined.
4.2 A computer program, e.g. programming code, e.g. prediction algorithm, which is an equation comprising the predicted dose or the predicted area under the curve as hereinabove defined.
5. A recoding medium comprising the computer program as hereinabove defined.
6.1 A data processing apparatus, e.g. a computer, operable to execute the computer program as hereinabove defined.
6.2 A data processing apparatus, e.g. a computer, operable to generate the pharmacokinetic model as hereinabove defined, comprising: derivation logic operable to derive a pharmacokinetic model for MPA; correlation logic operable to determine a correlation between actual collected pharmacokinetic data for the administered drug and predicted pharmacokinetic data provided by the pharmacokinetic model; and adjusting logic operable to adjust terms of the pharmacokinetic model in response to the correlation.
6.3 A logic operable to perform the steps as defined under 6.2.
7. A method of determining an effective amount of a drug for treating or preventing transplantation rejection in a subject in need thereof comprising the steps of: a) inputting a plurality of parameters into a computer, wherein said parameters comprise gender, age, and body mass index of said subject; b) storing a computer program in said computer; c) calculating said effective amount from said computer program with said parameters;
wherein said drug is selected from a group consisting of MPA, a pharmaceutically acceptable salt thereof and a prodrug thereof, and the computer program is as described under 4.1 and 4.2.
8.1 A predicted dosing of MPA, based on MPA absorption rate, MPA lag time, the volume of distribution, MPA elimination rate and the body system rates of flow, as hereinabove described.
8.2 A predicted dosing of MPA preferably for stable patients, in accordance with the equation:

predicted dose=AUC_{target}/((u*exp(e*lag)*(exp(−e*tlast)−exp(−e*lag))/(−e)+w*exp(f*lag)*(exp(−f*tlast)−exp(−f*lag))/(−f)−(u+w)*exp(ka*lag)*(exp(−ka*tlast)−exp(−ka*lag))/(−ka))),
wherein AUC_{target}; tlast; ka; lag; v; e; f; u; and w are as hereinabove defined (Equation P1).
8.3 A predicted dosing of MPA, preferably for de novo patients, in accordance with the equation:

predicted dose=AUC_{target}/(b₁*c₁*exp(d₁)−b₁*c₁*exp(e₁)) (Equation P2),
wherein b₁; c₁; d₁; and e₁ are as hereinbelow described.
8.4 A predicted dosing of MPA in accordance with the equation:

Predicted dose=dummy*f(dose,s)+(1−dummy)*f(dose,d);
wherein dummy; f(dose,s) and f(dose,d) are as hereinbelow described.
9.1 A predicted area under the curve of MPA, based on MPA absorption rate, MPA lag time, the volume of distribution, MPA elimination rate and the body system rates of flow, as hereinabove described.
9.2 A predicted area under the curve of MPA, preferably for stable patients, in accordance with the following equation:

predicted area under the curve=dose*((u*exp(e*lag)*(exp(−e*tlast)−exp(−e*lag))/(−e)+w*exp(f*lag)*(exp(−f*tlast)−exp(−f*lag))/(−f)−(u+w)*exp(ka*lag)*(exp(−ka*tlast)−exp(−ka*lag))/(−ka))), (Equation A1)
wherein dose; u; e; lag; tlast; w; f; ka; are as hereinabove described.
9.3 A predicted area under the curve of MPA, preferably for de novo patients, in accordance with the following equation:

predicted area under the curve=dose*b₁*c₁*exp(d₁)−dose*b₁*c₁*exp(e₁); (Equation A2)
wherein b₁; c₁; d₁; dose; and e₁ are as hereinabove described.
9.4 A predicted area under the curve of MPA in accordance with the following equation

Predicted area under the curve=dummy*f(AUC₀₋₁₂,s)+(1−dummy)*f(AUC₀₋₁₂,d) (Equation P3),
wherein dummy; f(AUC₀₋₁₂,s); and f(AUC₀₋₁₂,d) are as hereinabove described.
10. A method, e.g. a Baysian approach, to provide optimised pharmacokinetic data associated with administering MPA to a subject, e.g. a transplant patient, the method comprising the steps of: a) deriving a pharmacokinetic model for MPA; b) determining a correlation between actual collected pharmacokinetic data for administered MPA and predicted pharmacokinetic data provided by the pharmacokinetic model; and c) adjusting terms of the pharmacokinetic model in response to the correlation, wherein MPA is administered as mycophenolic acid (MPA), pharmaceutically acceptable salt or prodrug thereof.

Accordingly, particular physiological data relating to the subject to which MPA is to be administered is collected. This physiological data is then provided to the pharmacokinetic model which then provides the required pharmacokinetic data. It will be appreciated that in this way, optimised pharmacokinetic data can be provided based on the physiological characteristics of the subject.

In one embodiment, the model includes terms comprising one or more of a MPA absorption rate, MPA lag time, volume of distribution, MPA elimination rate and body system rates of flow, as hereinabove defined.

According to the invention, Baysian approach refers to an approach to statistics in which estimates are based on a synthesis of a prior distribution and current sample data. The bayesian procedures formally utilize information available from sources other than the statistical investigation. Such information, available through expert judgment, past experience, or prior belief, is described by a probability distribution on the set of all possible values of the unknown parameter of the statistical model at hand. This probability distribution is called the prior distribution.

The present invention recognises that techniques for determining pharmacokinetic data associated with administering a drug, e.g. MPA, are largely empirical and can result in wide variations. Accordingly, an initial pharmacokinetic model is derived for MPA which may typically be based upon information about MPA. The pharmacokinetic model may typically provide pharmacokinetic data in response to predetermined data relating to a subject, e.g. transplant patient, to which MPA is to be administered. A determination may then be made of the correlation between actual collected pharmacokinetic data for MPA when administered to a subject and the predicated pharmacokinetic data produced by the pharmacokinetic model. Terms within the initial pharmacokinetic model may then adjusted based on the correlation or variation between the actual and predicated pharmacokinetic data.

In this way, it can be seen that the pharmacokinetic model of the invention, e.g. a Basyan approach, may be optimised in order to provide increasingly accurate predicted pharmacokinetic data. It will be appreciated that the use of such predicted pharmacokinetic data can then enable more effective MPA treatments to be provided.

In one embodiment, the step a) comprises: a1) determining population pharmacokinetic factors of MPA; and a2) providing terms within the pharmacokinetic model which model the subject's influence on individual pharmacokinetic factors of MPA.

Accordingly, population pharmacokinetic factors of MPA are determined. It will be appreciated that these factors may be based on existing empirical data relating to MPA for different populations or based on knowledge of the pharmaceutical operation of MPA. Terms are then provided within the pharmacokinetic model which helps to quantify how characteristics of the subject influence these pharmacokinetic factors of MPA. For example, if it is known that the heart rate of a patient is the main contributing factor to the pharmacokinetics of MPA then the model may include a term related to the heart rate of the subject to which MPA is being administered. Similarly, if MPA is affected by the rate of absorption by the subject then the model may include terms such as the age and body mass index of the subject.

In one embodiment, the terms comprise one or more of a drug absorption rate, a drug lag time, a volume of distribution, a drug elimination rate and body system rates of flow.

Accordingly, various terms within the pharmacokinetic model can be provided based on the pharmacokinetic factors of MPA and characteristics of the subject which influence these factors.

In one embodiment, the step b) comprises: b1) isolating individual pharmacokinetic factors of MPA; b2) a plotting curve based each individual pharmacokinetic factor; b3) deriving terms that define each curve; and b4) deriving the predetermined constants based on characteristics of each curve.

In one embodiment, the step c) comprises: adjusting the predetermined constants to reduce variance between the actual collected pharmacokinetic data for the administered drug and the predicted pharmacokinetic data.

By adjusting the constants within the model, the correlation between the predicted and actual data can be improved.

According to the invention, there is also provided
11. A pharmacokinetic model, e.g. Baysian approach, operable to provide optimised pharmacokinetic data associated with administering MPA to a subject from collected physiological data relating to the subject, the pharmacokinetic model comprising: terms comprising one or more of a MPA absorption rate, a MPA lag time, a volume of distribution, a MPA elimination rate and body system rates of flow, wherein MPA is administered as MPA, a pharmaceutically acceptable salt or produg thereof.
12. A system for determining, e.g. predicting, an effective amount of a drug selected from MPA, a pharmaceutically acceptable salt salt or a prodrug thereof, which includes a computer system, e.g. a microprocessor based server such as SUN WORKSTATION or WINDOWS NT server or other computer system having suitable processing power and storage.

Computer system includes, for example, a central processing unit, random access memory, input/output device(s) and display coupled via a conventional bus. Also coupled to bus is a storage device such as a hard disk drive. Memory could include, for example, various modules necessary to carry out the method according the present invention as described above. A user can, for example, access the computer system through a dedicated communications link such as T1 or T3 or via a public network such as the Internet. The computer system can provide the requested information in real time or have the requested information processed ahead of time and retrieved from a storage device.

Additional advantages and modifications will readily occur to those skilled in the art.

### BRIEF DESCRIPTION OF THE DRAWINGS

The present invention will be described further, by way of example only, with reference to preferred embodiments thereof as illustrated in the accompanying drawings in which:

FIG. 1 is a flowchart illustrating a method of generating a pharmacokinetic model according to one embodiment;

FIG. 2 is a flow diagram illustrating a method of optimising pharmacokinetic data according to one embodiment;

FIG. 3 illustrates an example pharmacokinetic model; and

FIG. 4 illustrates a data processing apparatus utilising a pharmacokinetic model according to one embodiment.

### DESCRIPTION OF THE EMBODIMENTS

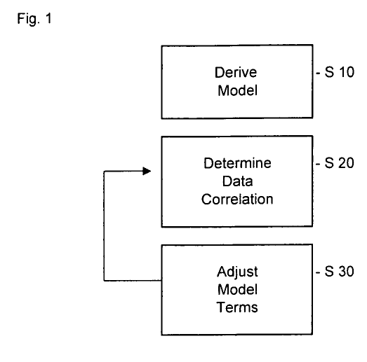

FIG. 1 illustrates a method of generating an optimised pharmacokinetic model according to one embodiment.

At step S10, an initial pharmacokinetic model is derived. This is initially achieved by determining population pharmacokinetic factors associated with MPA. Terms are then provided within the pharmacokinetic model which model a subject's influence on individual pharmacokinetic factors of MPA. For example, if it is known that the main influence on the drug to be administered, i.e. MPA, is the amount of water contained within the subject's body then terms within the pharmacokinetic model are included related to the interaction of MPA with the amount of water contained in a body.

At step S20, actual pharmacokinetic data which has been collected from a representative sample of subjects is provided. This data is then compared with data predicted by the pharmacokinetic model. Statistical analysis is then performed to understand the extent of correlation between the actual data and the predicted data provided by the model. In particular, individual pharmacokinetic factors of MPA are isolated. A curve is then plotted based on each of those individual pharmacokinetic factors. Terms are then derived which define each curve. Predetermined constants may then be determined in order to provide a best match to that curve. These predetermined constants may then be applied to the relevant terms in the pharmacokinetic model.

At step S30, the constants associated with each term in the pharmacokinetic model are then adjusted in order to minimise variants between the predicted data and the actual collected data.

In this way, the correlation of the pharmacokinetic model with the actual data can be improved. It will be appreciated that for any form of MPA, e.g. for mycophenolate salt or mycophenolate prodrug, one or more pharmacokinetic models may be provided depending on the variation between particular sets of collected data.

The same model can be used for different population when administering the same drug with the adjustment for the characters of the population. For example, the equations for ka or kel maybe different if the population characters have different effect on them, e.g. because of different living standard, renal function, etc.

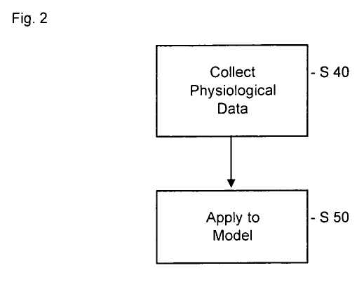

FIG. 2 illustrates use of the optimised pharmacokinetic model in more detail. At step S40, particular predetermined physiological data required by the model is collected for each subject. This physiological data may be details such as the gender of the subject, the subject's body mass index, the subject's age or other details that may be required by the model.

At step S50, the physiological data is supplied to the model which then provides the required predicated pharmacokinetic data. This predicted pharmacokinetic data, such as a specified dose of a drug or a predicted area under the curve to be used by the clinician when administering a drug.

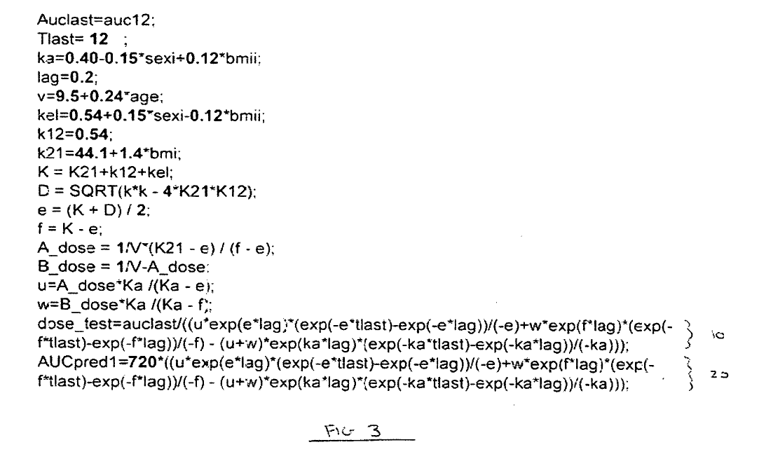

FIG. 3 illustrates in more detail an example pharmacokinetic model according to one embodiment.

The model has a variety of terms. The term “auc12” represent the target dosing level of MPA which is required. The term “Tlast” represents the time elapsed since the last administered dose. The term “ka” represents the absorption rate of MPA and is based on the gender and body mass index of the subject. The term “lag” represents the lag time of MPA. The term “v” is the volume of distribution and is based on the age of the subject. The term “kel” is MPA elimination rate and is based on the gender and the body mass index of the subject. The terms “k12” and “k21” are renal clearance, e.g. body system rates of flow, “k12” is a predetermined constant, whilst “k21” is based on the body mass index of the subject.

The terms “k”, “d”, “e”, “f”, “A_dose”, “B_dose”, “u” and “w” are derived terms based on the terms mentioned above.

In order to obtain a predicted dose for a particular patient, a dose_test equation, generally 10, is utilised as shown in FIG. 3. Similarly, in order to obtain a predicted area under the curve, an “AUCpred1” equation, generally 20, is used as illustrated in FIG. 3.

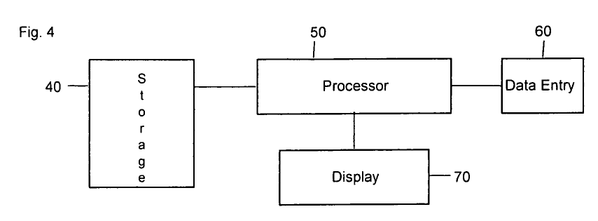

FIG. 4 illustrates a data processing apparatus, generally 30, which utilises a pharmacokinetic model according to one embodiment. The data processing apparatus 30 comprises a storage unit 40 coupled with a processor 50. Also coupled with the processor 50 is a data entry device 60 and a display 70.

The storage unit 40 will typically store the pharmacokinetic models. The storage 40 may also store actual pharmacokinetic data, together with tools for deriving a pharmacokinetic model and for determining correlation between the actual pharmacokinetic data and data predicted by the pharmacokinetic model.

Control of the models and of the tools is affected using the data entry device 60. Data produced by these tools is then displayed on the display 70.

When utilising the pharmacokinetic model to provide predicted pharmacokinetic data, a user may select the particular model to be used using the data entry means 60. Details of the subject patient may be entered using the data entry device 60 or, if already stored on the storage 40, retrieved from the storage 40. This data is then applied to the model using the processor 50.

The resultant predicted pharmacokinetic data is then provided to the display 70. The clinician then uses the displayed pharmacokinetic data to inform their decision on the amount of drug to be used.

In this way, it can be seen that the pharmacokinetic model can used to provide increasingly accurate predicted pharmacokinetic data which can then enable more effective treatments to be provided.

### EXAMPLES

334, 12 h plasma concentration/time profiles (217 for de novo and 117 for stable patients) are available from six clinical studies of transplant patients receiving enteric coated composition containing mycophenolate salt (Myfortic®) as part of their immunosuppressive drug regimen. Using 20 randomly selected profiles, population PK models (two-compartment for stable patients and a one-compartment for de novo patients) are developed using a Bayesian approach (i.e. approach to statistics in which estimates are based on a synthesis of a prior distribution and current sample data) to estimate the model parameters. The remaining profiles are used to test and validate the models.

Results: The one-compartment model predicts the mean and standard deviation (SD) of MPA AUC₀₋₁₂ for de novo patients who had been transplanted within the previous two weeks as 29.98±12.50 mg/L·h (measured f 32.25±17.47 mg/L·h); mean prediction error −4%. The two-compartment model predicts a mean value of 59.22±20.13 mg/L·h, (measured 65.08±26.01 mg/L·h); mean prediction error 2.13%.

Previous controlled studies of MPA suggested an optimal target AUC₀₋₁₂ of the order 45 mg/L·h immediately post-transplantation. 50% of our de novo patients given a fixed dose of 720 mg bid fell below the lower end of the target range for MPA AUC₀₋₁₂ (30 mg/L·h) during the two weeks after transplantation. To achieve the optimal concentration, a mean dose of 1268 mg bid is predicted for de novo patients. Similarly, to achieve 45 mg/L·h of MPA AUC₀₋₁₂ in the stable patients, the mean dose is predicted as 514 mg bid.

Although illustrative embodiments of the invention have been described herewith reference to the accompanying drawings, it is to be understood that the invention is not limited to those precise embodiment, and that various changes and modifications can be effected therein by one skilled in the art without departing from the scope of the invention as defined by the appended claims.

1. A method of predicting the effective amount of a drug selected from MPA, a pharmaceutically acceptable salt thereof and a prodrug thereof, for treating or preventing transplantation rejection, in a subject in need of such treatment, said method comprising the steps of
i) Obtaining information of gender, age, body mass index of the subject, and
ii) predicting the effective amount of the drug based on the parameters obtained under step i),
wherein said method does not require the use of biological samples from the subject.

2. The method according to claim 1 wherein the predicting is based on MPA absorption rate, volume of distribution, MPA elimination rate and renal clearance.

3. The method according to claim 1 wherein the predicting is based on target MPA AUC, MPA lag time and time between doses.

4. The method according to claim 1, wherein the predicting is for stable patient and is based on the equation:
predicted MPA dose=AUC_{target}/((u*exp(e*lag)*(exp(−e*tlast)−exp(−e*lag))/(−e)+w*exp(f*lag)*(exp(−f*tlast)−exp(−f*lag))/(−f)−(u+w)*exp(ka*lag)*(exp(−ka*tlast)−exp(−ka*lag))/(−ka))),
wherein
AUC_{target}=target MPA AUC;
tlast (time between doses)=12;
ka (MPA absorption rate)=0.40−0.15*sexi+0.12*bmii;
lag (MPA lag time)=0.2;
v (volume of distribution)=9.5+0.24*age;
kel (MPA elimination rate)=0.54+0.15*sexi−0.12*bmii;
k12 (rate constant between the central and second compartment)=0.54;
k21 (rate constant between the second and central compartment)=44.1+1.4*bmi;
K (first derived value)=k21+k12+kel;
D (second derived value)=SQRT(K*K−4*k21*k12);
e (third derived value)=(K+D)/2;
f (fourth derived value)=K−e;
A_dose (fifth derived value)=1/V*(k21−e)/(f−e);
B_dose (sixth derived value)=1/V−A_dose;
u (seventh derived value)=A_dose*Ka/(Ka−e);
w (eighth derived value)=B_dose*Ka/(Ka−f);
age is the age of the subject;
sexi is ‘0’ when the gender of the subject is male and ‘1’ when the gender of the subject is female;
bmi is the body mass index of the subject; and
bmii is ‘0’ when the bmi of the subject is outside the normal range [18, 25] and ‘1’ when the bmi of the subject is within [18, 25].

5. The method according to claim 1, wherein the predicting is for de novo patient and is based on the equation:
predicted MPA dose=AUC_{target}/(b₁*c₁*exp(d₁)−b₁*c₁*exp(e₁))
wherein
AUC_{target}=target MPA AUC
Ka₁=0.98−0.05*sexi-0.014*bmi+0.006*sqrt(age);
lag₁=0.01−0.0003*sqrt(age)−0.0001*sexi−0.0001*bmib;
v₁=60.82+0.08*sqrt(age)+25*bmii;
kel₁=0.11+0.003*bmi−0.0085*sqrt(age)−0.01*sexi;
b₁=(−kel₁)/(v₁*(Ka₁−kel₁));
c₁=tlast₁−lag₁;
d₁=(−ka₁*(tlast−lag₁));
e₁=ka₁*lag₁;
age is the age of the subject;
sexi is ‘0’ when the gender of the subject is male and ‘1’ when the gender of the subject is female;
bmi is the body mass index of the subject; and
bmii is ‘0’ when the bmi of the subject is outside the normal range [18, 25] and ‘1’ when the bmi of the subject is within [18, 25]; and
bmib is ‘0’ when bmi of the subject is less than 30 and ‘1’ when the bmi of the subject is greater than 30.

6. The method according to claim 1, to predict a MPA exposure in stable patient and is based on the equation:
predicted MPA AUC=dose*((u*exp(e*lag)*(exp(−e*tlast)−exp(e*lag))/(e)+w*exp(f*lag)*(exp(−f*tlast)−exp(−f*lag))/(−f)(u+w)*exp(ka*lag)*(exp(−ka*tlast)−exp(−ka*lag))/(−ka))),
wherein
dose is the administered dose of the drug;
tlast; ka; lag; v; kel; k12; k21; K; D; e; f; A_dose; B_dose; u; w; age; sexi; bmi; and bmii are as defined under claim 4.

7. The method according to claim 1, to predict a MPA exposure in de novo patient and is based on the equation:
predicted MPA AUC=dose*b₁*c₁*exp(d₁)−dose*b₁*c₁*exp(e₁);
wherein
dose is the administered dose of the drug;
Ka₁; lag₁; v₁; kel₁; b₁; c₁; d₁; e₁; age; sexi; bmi; bmii; and bmib are as defined under claim 5.

8. The method according to claim 1, wherein the predicting is based on the equation:
Predicted dose=dummy*f(dose,s)+(1−dummy)*f(dose,d);
wherein
dummy=1 when patients are stable, and dummy=0 when patients are de novo patients;
f(dose,s) is equation for predicted dose in case of stable patient, preferably equation according to claim 4;
f(dose,d) is equation for predicted dose in case of de novo patient, preferably equation according to claim 5.

9. The method according to claim 1, wherein the predicting is based on the equation:
predicted area under the curve=dummy*f(AUC₁₋₁₂,s)+(1−dummy)*f(AUC₁₋₁₂,d)
wherein
dummy=1 when patients are stable, and dummy=0 when patients are de novo patients;
f(AUC₀₋₁₂,s) is equation for predicted area under the curve in case of stable patient, preferably equation according to claim 6;
f(AUC₀₋₁₂,d) is equation for predicted area under the curve in case of de novo patient, preferably equation according to claim 7.

10. The method according to claim 1, wherein the drug comprises mycophenolate, preferably in a form of an enteric coated formulation.

11. The method according to claim 10, wherein the drug is mycophenolate sodium, preferably enteric coated mycophenolate sodium.

12. A pharmacokinetic model to determine the effective amount of a drug selected from MPA, a pharmaceutically acceptable salt thereof and a prodrug thereof, for treating or preventing transplantation rejection, in a subject in need of such treatment, wherein said model determines the effective amount of the drug based on the gender, age, body mass index of the subject.

13. The model according to claim 12 which is based on MPA absorption rate, volume of distribution, MPA elimination rate and renal clearance.

14. The model according to claim 12 which is based on target dose, MPA lag time and time between doses.

15. The model according to claim 12, wherein the model is for stable patent and is based on the equation:
predicted MPA dose=AUC_{target}/((u*exp(e*lag)*(exp(−e*tlast)−exp(−e*lag))/(−e)+w*exp(f*lag)*(exp(−f*tlast)−exp(−f*lag))/(−f)−(u+w)*exp(ka*lag)*(exp(−ka*tlast)−exp(−ka*lag))/(−ka))),
wherein
AU_{target}; tlast; ka; lag; v; kel; k12; k21; K; D; e; f; A_dose; B_dose; u; w; age; sexi; bmi; and bmii are as defined under claim 4.

16. The model according to claim 12, wherein the model is for de novo patient and is based on the equation:
predicted MPA dose=AUC_{target}/(b₁*c₁*exp(d₁)−b₁*c₁*exp(e₁)),
wherein
AU_{target}; Ka₁; lag₁; v₁; kel₁; b₁; c₁; d₁; e₁; age; sexi; bmi; bmii; and bmib are as defined under claim 5.

17. The model according to claim 12, which is for stable patient
and is based on the equation:
predicted MPA AUC=dose*((u*exp(e*lag)*(exp(−e*tlast)−exp(e*lag))/(e)+w*exp(f*lag)*(exp(−f*tlast)−exp(−f*lag))/(−f)(u+w)*exp(ka*lag)*(exp(−ka*tlast)−exp(−ka*lag))/(−ka))),
wherein
dose is the administered dose of the drug;
tlast; ka; lag; v; kel; k12; k21; K; D; e; f; A_dose; B_dose; u; w; age; sexi; bmi; and bmii are as defined under claim 4.

18. The model according to claim 12, which is for de novo patient and is based on the equation:
predicted MPA AUC=dose*b₁*c₁*exp(d₁)−dose*b₁*c₁*exp(e₁);
wherein
dose is the administered dose of the drug;
b₁; c₁; d₁; and e₁ are as defined under claim 5.

19. The model according to claim 12, wherein the model is based on the equation:
predicted MPA dose=dummy*f(dose,s)+(1−dummy)*f(dose,d);
wherein
dummy=1 when patients are stable, and dummy=0 when patients are de novo patients;
f(dose,s) is equation for predicted dose in case of stable patient, preferably equation according to claim 15;
f(dose,d) is equation for predicted dose in case of de novo patient, preferably equation according to claim 16.

20. The model according to claim 12, which is based on the equation:
predicted MPA AUC=dummy*f(AUC₀₋₁₂,s)+(1−dummy)*f(AUC₀₋₁₂,d);
wherein
dummy=1 when patients are stable, and dummy=0 when patients are de novo patients;
f(AUC₀₋₁₂,s) is equation for predicted area under the curve in case of stable patient, preferably equation according to claim 17;
f(AUC₀₋₁₂,d) is equation for predicted area under the curve in case of de novo patient, preferably equation according to claim 18.

21. The model according to claim 12, wherein the drug comprises mycophenolate, preferably in a form of an enteric coated formulation.

22. The model according to claim 21, wherein the drug is mycophenolate sodium, preferably enteric coated mycophenolate sodium.

23. A computer program which, when executed on a computer, performs the method steps of the method defined under claim 1.

24. A recoding medium comprising the computer program of claim 23.

25. A data processing apparatus operable to execute the computer program of claim 23.

26. A method for treating or preventing transplantation rejection, in a subject in need of such treatment, which method comprises administering to said subject an effective amount of a drug selected from MPA, a pharmaceutically acceptable salt thereof and a prodrug thereof, wherein the effective amount is predicted by a method according to claim 1.

27. (canceled)

28. A method for generating a pharmacokinetic model to determine the effective amount of a drug selected from MPA, a pharmaceutically acceptable salt thereof and a prodrug thereof, for treating or preventing transplantation rejection in a subject in need of such treatment, said model being based on the gender, age, body mass index of the subject, wherein said method comprising the steps of:
a) deriving a pharmacokinetic model for the drug;
b) determining a correlation between actual collected pharmacokinetic data for the administered drug and predicted pharmacokinetic data provided by the pharmacokinetic model; and
c) adjusting terms of the pharmacokinetic model in response to the correlation.

29. The method according to claim 28, wherein the model is further based on one or more of MPA absorption rate, MPA lag time, volume of distribution, MPA elimination rate, body system rates of flow and time between doses.

30. The method according to claim 28, wherein the drug comprises mycophenolate, preferably in a form of an enteric coated formulation.

31. The method according to claim 30, wherein the drug is mycophenolate sodium, preferably enteric coated mycophenolate sodium.

32. A method of determining an effective amount of a drug for treating or preventing transplantation rejection in a subject in need thereof comprising the steps of:
a) inputting a plurality of parameters into a computer, wherein said parameters comprise gender, age, and body mass index of said subject;
b) storing a computer program in said computer;
c) calculating said effective amount from said computer program with said parameters;
wherein said drug is selected from a group consisting of MPA, a pharmaceutically acceptable salt thereof and a prodrug thereof.
